(19) United States
(12) Patent Application Publication
(10) Pub. No.: US 2021/0252745 A1
(43) Pub. Date: Aug. 19, 2021

(54) Method for Recovering Aluminum from Multilayered Packaging Utilizing Sonication and Formic Acid

(71) Applicants: NEHA S CHOPADE, MADISON, AL (US); PUJA S CHOPADE, MADISON, AL (US); PRANAV C SOMU, MADISON, AL (US); SHUBHAM P. CHOPADE, MADISON, AL (US)

(72) Inventors: NEHA S CHOPADE, MADISON, AL (US); PUJA S CHOPADE, MADISON, AL (US); PRANAV C SOMU, MADISON, AL (US); SHUBHAM P. CHOPADE, MADISON, AL (US)

(21) Appl. No.: 16/794,795

(22) Filed: Feb. 19, 2020

(51) Int. Cl. B29B 17/02; C22B 21/00; C08J 11/26

(52) U.S. Cl. CPC B29B 17/02; C22B 21/0023; C08J 11/26; B29B 2017/001; C08J 2323/12; B29B 2017/0268; B29B 2017/0293; C08J 2323/06

(57) ABSTRACT

The process disclosed herein is method of recovering aluminum from multilayered packaging. The process comprises subjecting multilayered packaging to a reactor with aqueous formic acid, wherein the solution is sonicated using sonic horns. This process allows the recovery of aluminum in its pure metal form. PP/PE components of the multilayered packaging are recovered utilizing density separation, while ink and PET components require further treatment in a toluene reactor which may include sonication.

### CROSS-REFERENCE TO RELATED APPLICATIONS

This application does not claim priority to any patent application.

### DISCLOSURE REGARDING PRIOR DISCLOSURES BY THE INVENTOR OR A JOINT INVENTOR

The inventors have not disclosed this invention prior to the filing of this non-provisional application.

### BACKGROUND OF THE INVENTION

### (1) Field of the Invention

This method improves the recovery of aluminum from waste during recycling. Much of the packaging utilized in food packaging, such as chip packaging, is composed of multiple layers of plastic and aluminum. The multiple layers are typically adhered to each other so that they are difficult to separate into the individual layers, making it expensive and time consuming to recover individual recyclable components. Currently, there is not any practical method of recovering the aluminum utilized in multilayered packaging, making it difficult to recycle food packaging.

### (2) Disclosure of the Prior Art

The amount of multilayered packaging waste produced annually is increasing, likely due to an increase in demand for prepackaged food. Multilayered packaging typically includes at least one metal layer, usually aluminum, and at least one layer of plastic. Aluminum is included to reduce food damage due to oxidation and moisture, while plastic film layers may be laminated onto the aluminum to enable printing on the exterior of the packaging and laminated onto the other side of the aluminum to serve as a liner for food storage. The layers are laminated using adhesives, which are called tie layers Although aluminum and plastic individually are recyclable, multilayered packaging is generally non-recyclable due to an inability to easily and cheaply separate aluminum from the plastic layers.

Aluminum is known to dissolve in strong bases such as NaOH and KOH. Mukhopadhyay (U.S. Pat No. 8,945,396 B2) discloses a process for delaminating multilayered laminated packaging waste using strong bases. The method comprises using a mixture of inorganic bases to separate the paper pulp, plastic and aluminum wherein the aluminum is recovered as a water soluble salt. The inorganic bases dissolve the aluminum into sodium aluminates which precipitate onto the bottom of the solution as water insoluble aluminum hydroxide gel, which can be filtered out. Lee et al. (U.S. Pat. No. 7,598,297 B2) discloses subjecting pulverized multilayered packaging waste to an alkali aqueous solution (such as NaOH, KOH, Ca(OH)₂, or LiOH) so that the aluminum layer is deposited into the alkali aqueous solution, and is separated from the solution using neutralization, or a similar process. The bases used in these processes are strong bases that may be corrosive and hazardous when inhaled. The use of these strong bases make these processes expensive to perform. Additionally, the aluminum recovered via this process is an aluminum salt, which is of much lesser value than aluminum in pure metal form.

Aluminum is known to dissolve in strong acid, such as hydrochloric and sulfuric acid, producing highly flammable hydrogen gas. Gabl (U.S. Pat. No. 10,046,978 B2) discloses a process of recovering aluminum from multilayered packaging utilizing highly concentrated hydrochloric acid having high temperature with continuous mixing. Hydrochloric acid treatment dissolves the aluminum into solution producing hydrogen gas as a byproduct. Then the solution is subjected to pyrohydrolytic treatment, which is typically conducted at 700-900 C, to recover aluminum oxide. Gabl discloses grinding aluminum oxide using a liquid medium and ultrasound. In this method, aluminum oxide is recovered. Aluminum oxide has a significantly lower value than pure aluminum metal and requires additional processing steps to convert the aluminum oxide to a recyclable form.

The process disclosed by Gabl is expensive to use because of the high costs associated with handling hydrogen gas byproducts and the expense of pyrohydrolytic treatment. A method of separating aluminum from adhesives that does not produce flammable byproducts or require high heat would reduce the costs of recycling, thus, increasing the percentage of multilayered packaging recycled.

### (e) BRIEF SUMMARY OF THE INVENTION

The invention herein is a process for separating aluminum contained within multilayered packaging from the multiple layers by dissolving adhesives used to bind the multiple layers. The process utilizes formic, or methanoic acid, and ultrasound. This process does not produce flammable byproducts or require high temperature conditions.

### BRIEF DESCRIPTION OF THE DRAWINGS

The invention is described in detail below with reference to the appended drawings. FIGS. 1 through 3 depict the Method for Recovering Aluminum from Multilayered Packaging Utilizing Sonication and Formic Acid. In the Figures:

FIG. 1 depicts a mid-sectional view of a multilayered package.

FIG. 2 depicts a bottom, angled view of FIG. 1 wherein the layers have been separated.

FIG. 3 is a flow chart of the method disclosed herein.

### DETAILED DESCRIPTION OF THE INVENTION

While this invention is susceptible of embodiment in many different forms, there are shown in the drawings and will herein be described in detail, several embodiments with the understanding that the present disclosure should be considered as an exemplification of the principles of the invention and is not intended to limit the invention to the embodiments so illustrated. Further, to the extent that any numerical values or other specifics of materials, etc., are provided herein, they are to be construed as exemplifications of the inventions herein, and the inventions are not to be considered as limited thereto.

The following description and drawings are illustrative and are not to be construed as limiting. Numerous specific details are described to provide a thorough understanding of the disclosure. However, in certain instances, well-known or conventional details are not described in order to avoid obscuring the description. References to one, or an embodiment in the present disclosure, can be, but not necessarily, references to the same embodiment; and, such references mean at least one of the embodiments.

Reference in this specification to “one embodiment’ or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments, but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same term can be said in more than one way.

Consequently, alternative language and synonyms may be used for any one or more of the terms discussed herein, or is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

Today's plastic packaging films are most often multilayered films that combine the properties of two or more materials. The combination of different polymer layers lowers the gas and vapor permeability, reduces cost, and improves the mechanical properties of the packaging film, such as puncture and tear resistance. However, often dissimilar materials, when coextruded to a multilayer film, do not adhere well to each other. To improve adhesion between poorly adhering layers, special adhesive polymers or tie resins, also called tie layers, have been developed. These resins are typically polyethylene copolymers of polar and non-polar repeat units and with or without functional reactive groups.

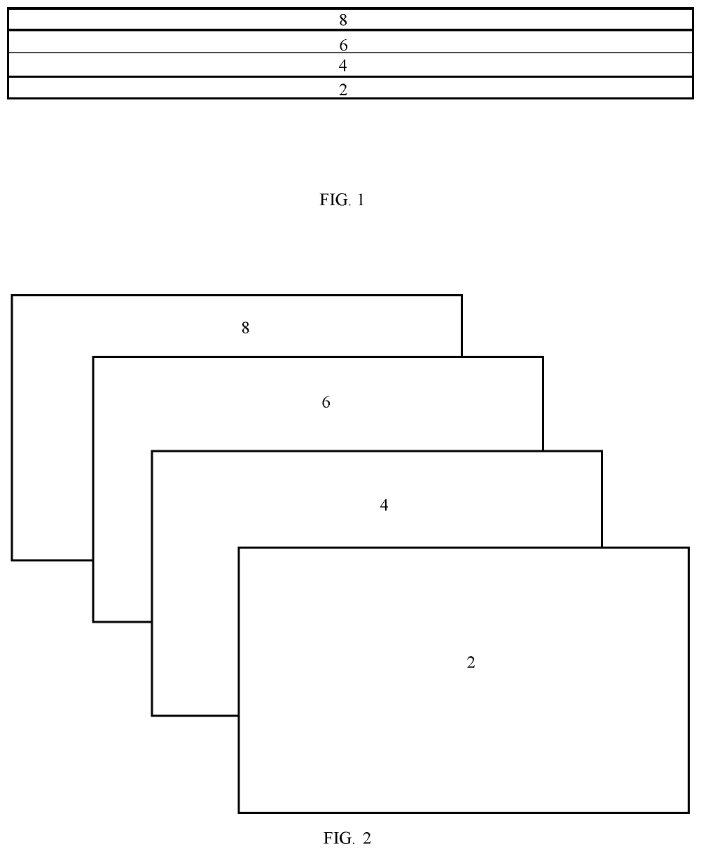

FIG. 1 depicts a mid-sectional view of an exemplary multilayered package. Inner layer 2 is the innermost plastic layer and may be composed of polypropylene (PP) or polyethylene (PE), or a similar material. Metal layer 4 may be vacuum deposited onto inner layer 2. Metal layer 4 may be aluminum. Metal layer 4 may be adhered to outer layer 8 via tie layer 6. Outer layer 8 may be composed of plastic such as polyethylene terephthalate (PET) or similar material. Outer layer 8 may be printed with advertising or content material. Tie layer 6 may be composed of a resin that serves as an adhesive to attach outer layer 8 to metal layer 4. Tie layer 6 may include ethylene vinyl acetate (EVA) and ethylene methyl acrylate (EMA), acid modified olefin copolymers like ethylene acrylic acid (EAA) and ethylene methacrylic acid (EMAA). Tie layers are typically considered non-reactive because none or only a small portion of the acid groups undergo chemical reactions. Tie layer resins provide adhesion to many polar polymers because they form strong hydrogen and polar bonds with many polar polymers utilized in multilayered food packaging.

A bottom, angled view of FIG. 1 with the layers separated from each other is shown in FIG. 2. Inner layer 2 is placed next to metal layer 4, which is shown layered next to tie layer 6, which is coupled to outer layer 8. Tie layer 6 is a chemical layer, wherein inner layer 2, metal layer 4, and outer layer 8 are structural layers.

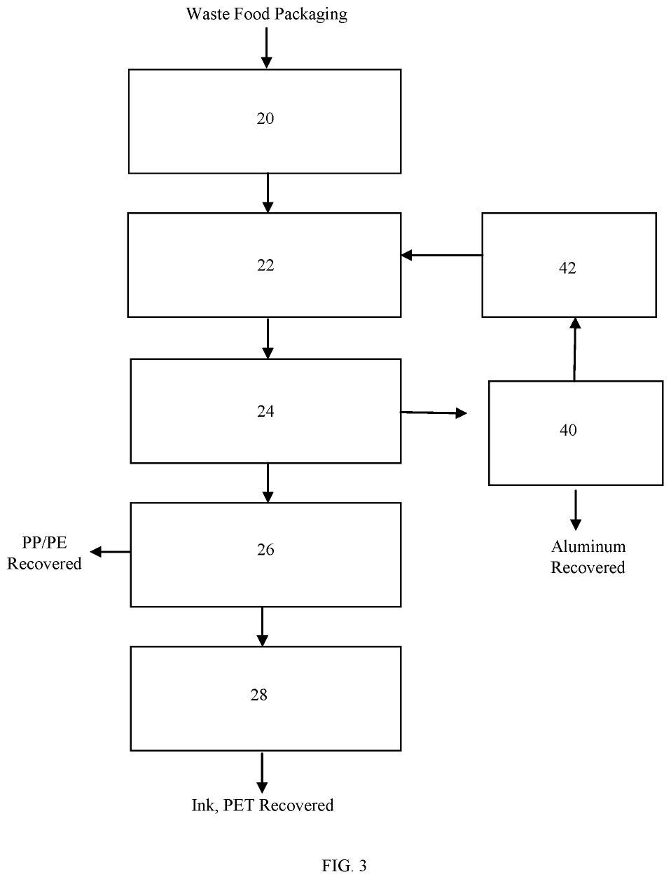

This process significantly reduces the processing time from hours to minutes and increases the efficiency of processing allowing recycling to be conducted as a flow process rather than a batch process, which is the current method employed. FIG. 3 is a flow chart depicting the process disclosed herein.

Waste food multilayered packaging enters shredder 20 where it is mechanically shredded into small pieces (e.g. 1 cm×2 cm). Shredder 20 may be a conventional shredder. Once waste food multilayer packaging is shredded, it is pumped via pump 22 through a tube into formic acid reactor 24. Pump 22 may be a peristaltic pump or similar means that forces the shredded pieces of packaging through a tube into formic acid reactor 24. Formic acid reactor 24 may contain an aqueous solution of formic acid diluted to a final concentration of 5% to 100% formic acid in solution. The temperature of formic acid reactor 24 may be maintained from 25° C. to 75° C. Generally, an increase in the temperature maintained within formic acid reactor 24 causes an increase in the rate at which metal layer 4 is separated from inner layer 2 and tie layer 6. And, an increase in the reactor temperature causes an increase in the efficiency of separation achieved. The increases in rate of reaction and efficiency of reaction can be exponential.

Formic acid reactor 24 may include one or more ultrasonic horns or other sources of ultrasonic waves. Ultrasonic energy may be utilized within the reactor to catalyze the separation of metal layer 4 from outer layer 8 and inner layer 2 via cavitation. The size of the ultrasonic horn employed to maximize the cavitation zone within formic acid reactor 24 may vary based on the size of the reactor used. Generally, an increase in wattage in the ultrasonic horn creates an increase in effectiveness of formic acid reactor 24.

The ultrasound waves causes an increase in the rate of reaction within formic acid reactor 24. Also, ultrasonic waves provide mechanical vibration that physically masticates the shredded food multilayered packaging causing metal layer 4 to flake into pieces separating bits of metal layer 4 from the other layers. Metal layer 4 flakes may tend to precipitate onto the bottom of formic acid reactor 24, while bits of inner layer 2 and outer layer 8 may rise and float. At density separator 40, flakes of metal layer 4 may be separated from the aqueous solution and recycled. Density separator 40 may include vacuum filtration. Aqueous solution containing formic acid may be returned to pump 22 via return pump 42, and pumped from pump 22 to formic acid reactor 24. Formic acid solution may be cycled through formic acid reactor 24 multiple times. Some embodiments may allow for recycling of formic acid solution through formic reactor 24 up to five times.

Generally, an increase in wattage in the ultrasound horn creates an increase in effectiveness for formic acid reactor 24. Ultrasound may be applied at formic acid reactor 24 to enhance the rate of reaction within the reactor. The size of the ultrasonic horn needed to maintain the cavitation zone will depend on the size of the formic acid reactor employed. A typical ultrasound power of 225 watts may be utilized in a standard reactor.

Bits of inner layer 2 and outer layer 8 may be transferred from formic acid reactor 24 to density separator 26 via transfer of aqueous solution from formic acid reactor 24. At density separator 26, the PP/PE plastic layer is separated from the PET plastic layer via density separation. PET has a significantly different density than PP/PE plastic and separates via density. The recovered PP/PE may be melted into new plastic products.

Once PP/PE is recovered at density separator 26, the remaining aqueous solution may be transferred to toluene reactor 28. At toluene reactor 28, the solution may be subjected to toluene for a sufficient amount of time, typically five to fifteen minutes, at a temperature that may be not less than 25° C. and not more than 75° C. Additionally, an increase in the temperature maintained within toluene reactor 28, increases the rate that the ink is converted into a particulate reducing the processing time necessary. The effect of temperature on the rate and efficiency of separation can be exponential, and the greatest decrease in processing time may be seen when increasing the reactor temperature from 25° C. to 35° C.

Generally, an increase in wattage in the ultrasonic horn creates an increase in effectiveness of toluene reactor 28. Ultrasound may be applied at toluene reactor 28 to enhance the rate of reaction within the reactor. The size of the ultrasonic horn needed to maintain the cavitation zone will depend on the size of the reactor employed. A typical ultrasound power of 225 watts may be utilized in a standard toluene reactor. Any ink utilized on outer layer 8 will be converted to particulate form at toluene reactor 28. Ink particulate may be removed via gravity filtration and recycled. PET may be removed from toluene reactor 28 after processing, and recycled.

We claim:

1. A method of recovering aluminum from multilayered packaging comprising:
shredding multilayered packaging with a mechanical shredder until the multilayered packaging is reduced to small fragments,
subjecting the small fragments to an aqueous solution of formic acid, wherein the aqueous solution is maintained at a minimum temperature of 25 degrees Celsius and a maximum temperature of 75 degrees Celsius,
subjecting the aqueous solution of formic acid containing the small fragments to sonication until aluminum separates from the small fragments as pure aluminum metal, and
filtering the pure aluminum metal from the aqueous solution of formic acid utilizing density separation.

2. The method of claim 1 wherein a sonic horn producing sonic waves at 250 watts provides the sonication.

3. The method of claim 1 wherein the small fragments have a maximum width of 1 cm and a maximum length of 2 cm.

4. A method of recovering polypropylene or polyethylene from multilayered packaging comprising:
shredding multilayered packaging with a mechanical shredder until the multilayered packaging is reduced to small fragments,
subjecting the small fragments to an aqueous solution of formic acid, wherein the aqueous solution is maintained at a minimum temperature of 25 degrees Celsius and a maximum temperature of 75 degrees Celsius,
subjecting the aqueous solution of formic acid containing the small fragments to sonication until aluminum separates from the small fragments as pure aluminum metal, and
filtering the polypropylene or polyethylene from the aqueous solution of formic acid utilizing density separation.

5. The method of claim 4 wherein aluminum is filtered from the aqueous solution of formic acid utilizing density separation before the polypropylene or polyethylene is filtered from the aqueous solution of formic acid.

6. The method of claim 4 wherein the small fragments have a maximum width of 1 cm and a maximum length of 2 cm.

7. The method of claim 4 wherein pure aluminum metal is separated from the aqueous solution of formic acid by filtering the pure aluminum metal from the aqueous solution of formic acid utilizing density separation.

8. A method of recovering polyethylene terephthalate from multilayered packaging comprising:
shredding multilayered packaging with a mechanical shredder until the multilayered packaging is reduced to small fragments,
subjecting the small fragments to an aqueous solution of formic acid, wherein the aqueous solution is maintained at a minimum temperature of 25 degrees Celsius and a maximum temperature of 75 degrees Celsius,
subjecting the aqueous solution of formic acid containing the small fragments to sonication until aluminum separates from the small fragments as pure aluminum metal,
subjecting a polyethylene terephthalate layer of the small fragments to toluene, wherein the toluene is maintained at a minimum temperature of 25 degrees Celsius and a maximum temperature of 75 degrees Celsius,
subjecting the toluene to sonication until the polypropylene terephthalate layer separates from the small fragments, and
filtering the polyethylene terephthalate layer from the toluene utilizing density separation.

9. The method of claim 8 wherein the small fragments have a maximum width of 1 cm and a maximum length of 2 cm.

10. The method of claim 8 wherein ink is recovered from the toluene.

11. The method of claim 8 wherein pure aluminum metal is separated from the aqueous solution of formic acid by filtering the pure aluminum metal from the aqueous solution of formic acid utilizing density separation.

12. The method of claim 8 wherein polypropylene or polyethylene is separated from the aqueous solution of formic acid by filtering the polypropylene or polyethylene from the aqueous solution of formic acid utilizing density separation.

13. The method of claim 8 wherein pure aluminum metal is separated from the aqueous solution of formic acid by filtering the pure aluminum metal from the aqueous solution of formic acid utilizing density separation, and wherein polypropylene or polyethylene is separated from the aqueous solution of formic acid by filtering the polypropylene or polyethylene from the aqueous solution of formic acid utilizing density separation.
